(19) United States
(12) Patent Application Publication
(10) Pub. No.: US 2026/0016694 A1
(43) Pub. Date: Jan. 15, 2026

(54) FAST GRID-BASED SIMULATIONS OF WAVEGUIDES WITH SURFACE RELIEF GRATINGS

(71) Applicant: Microsoft Technology Licensing, LLC, Redmond, WA (US)

(72) Inventors: Tuomo Antero von LERBER, Helsinki (FI); Lasse-Petteri LEPPANEN, Kirkkonummi (FI)

(73) Assignee: Microsoft Technology Licensing, LLC, Redmond, WA (US)

(21) Appl. No.: 18/771,843

(22) Filed: Jul. 12, 2024

(51) Int. Cl. G02B 27/01; G02B 27/00; G02B 27/42; G06F 30/27; G06F 111/18

(52) U.S. Cl. CPC G02B 27/0172; G02B 27/0081; G02B 27/4205; G06F 30/27; G02B 2027/0174; G02B 2027/0178; G06F 2111/18

(57) ABSTRACT

A computer-based simulation of light propagation and interactions with a waveguide and optical elements in a waveguide combiner uses a model based on a neural network that inherits its shape and properties from a grid structure superimposed on a waveguide combiner. Machine learning is not utilized as weights between nodes in the network are based on physical and geometrical rules which removes the need for training. The waveguide combiner is modeled as a stack of two-dimensional layers that are divided into cells. The k-vector space describing direction and wavelength of diffracted beams for the waveguide combiner is adapted to be non-continuous such that k-vectors are discretized into individual bins that are respectively associated with the different layers. Simulation computations are carried out in a sequence of discrete steps directed to interactions among the cells in which light energy is exchanged with their neighbors from within and between layers.

### BACKGROUND

Simulations of light propagation in optical waveguide combiners used in display systems are commonly utilized to optimize design parameters, evaluate performance metrics, and explore alternative architectures. Using simulations, designs can be efficiently iterated before physical prototyping is undertaken to reduce costs and shorten development time.

### SUMMARY

A computer-based simulation of light propagation and interactions with a waveguide and coupling optics (e.g., diffractive surface relief gratings (SRGs)) supports field of view (FOV) analyses to enable efficient evaluation and balancing of various design parameters including FOV, image quality (e.g., brightness and uniformity), eyebox size, and overall display system complexity of a waveguide-based display system. Rather than utilize conventional ray-tracing techniques that are highly accurate but computationally slow and costly, a discretized grid-based waveguide model provides the foundation of a simulation tool that computes results in seconds rather than hours or days. While accuracy may be reduced compared to ray-tracing, the fast grid-based approach can be useful for expediting the early phases of design iterations in which changes in waveguide and optical couplers are occurring frequently and potential design solutions are sought to be vetted quickly.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### DESCRIPTION OF THE DRAWINGS

FIG. 1 is a block diagram of an illustrative mixed-reality display system;

FIG. 2 illustratively shows virtual images that are overlayed onto real-world images within a field of view (FOV) of a mixed-reality HMD device;

FIG. 3 shows illustrative components of a waveguide combiner used in a mixed-reality display system;

FIG. 4 shows an illustrative optical combiner comprising diffractive optical elements (DOEs) using surface relief grating (SRG) construction that are disposed on a waveguide;

FIG. 5 shows propagation of light in a waveguide by total internal reflection (TIR);

FIG. 6 shows multiplication of light rays from interactions with diffractive elements;

FIG. 7 is a graph showing various iterations of display system designs using a genetic algorithm;

FIG. 8 shows illustrative vertex points defining a physical geometry for a waveguide combiner;

FIG. 9 shows an illustrative grid structure that is superimposed on the waveguide combiner geometry that is modeled as a stack of two-dimensional layers;

FIG. 10 shows light propagation in an illustrative stack of layers of the modeled waveguide combiner;

FIG. 11 is an enlarged view of light propagation in a first layer of the stack of layers of the modeled waveguide combiner shown in FIG. 10;

FIG. 12 is an enlarged view of light propagation in a second layer of the stack of layers of the modeled waveguide combiner shown in FIG. 10;

FIG. 13 is an enlarged view of light propagation in a third layer of the stack of layers of the modeled waveguide combiner shown in FIG. 10;

FIG. 14 shows two illustrative layers of the modeled waveguide combiner in which vertex points are rotated along azimuth angles around a center origin;

FIG. 15 shows overlapping of cells between the layers shown in FIG. 14;

FIGS. 16-25 show screen-captures taken at one-second intervals of an illustrative grid-based simulation;

FIGS. 26, 27, and 28 are flowcharts of illustrative methods that are facilitated using the present principles;

FIG. 29 shows illustrative design parameters that may be varied to implement desired characteristics in a diffractive optical element (DOE) that is constructed as an SRG;

FIG. 30 shows various illustrative modulation schemes for a DOE that is constructed as an SRG;

FIG. 31 is functional block diagram of an illustrative HMD device;

FIG. 32 is a functional block diagram of an illustrative computing device that may be used, at least in part, to implement aspects of the present principles.

Like reference numerals indicate like elements in the drawings. Elements are not drawn to scale.

### DETAILED DESCRIPTION

Waveguide combiners in head-mounted display (HMD) devices supporting mixed-reality experiences use transparent optical waveguides and coupling optics that enable HMD device users to maintain awareness of their surroundings while viewing virtual content. Input and output couplers (and other optical components in some cases) are provided on the waveguide to steer light towards the user's eye overlaying virtual images onto their view of the real world. Waveguide combiners are commonly the most complex and costly components in an HMD device that define many principal characteristics such as eyebox dimensions, field of view, overall device size, and form-factor. During waveguide combiner design development, computer-based simulations are often used to model the optical performance of various materials, geometries and configurations, and coupling mechanisms to identify designs that meet target specifications.

Conventional ray-tracing simulations can be computationally intensive and very time-consuming depending on factors such as the number of rays modeled, wavelengths, surface area of the waveguide, and the number and properties of the optical elements that alter or steer the direction of propagation. The inventors have created an alternative method based on a neural network that inherits its shape and properties from a grid structure that is superimposed over the waveguide combiner geometry. The grid-based modeling method discretizes the k-vector space into non-continuous bins and divides the waveguide combiner into discrete cells. Time is also discretized in the modeling by performing the simulation computations in sequential steps.

In an illustrative example of the discretized grid-based waveguide model, the shape of the waveguide and locations of the SRG components are defined by vertex points. Design parameters for SRG components such as grating vector orientations, slant angles, depth modulation, and fill factors are also defined. A grid structure using a non-continuous spatial coordinate geometry defines cells on a waveguide combiner that is modeled as a stack of two-dimensional layers. The k-vector space for the waveguide and SRG components describing direction and wavelength of diffracted beams is adapted to be non-continuous such that k-vectors are discretized into individual bins that are respectively associated with the different layers. Simulation computations are carried out in a sequence of discrete steps directed to interactions among the cells in which light energy is exchanged with their neighbors from within and between layers.

The discretized grid-based waveguide model fundamentally treats light as an aggregate amount of optical power residing in a cell of the grid. Light propagation in the waveguide is modeled as if it were a liquid which flows, or leaks, from cell to cell from gravity along tilted surfaces of the waveguide layers. In the real world, coupling from SRG components causes light rays to propagate in different directions described by respective k-vectors. In the model, by comparison, the geometry is rotated such that each k-vector bin propagates in the same direction on its associated waveguide surface in a layer. The rotation of the waveguide geometry naturally changes the vertex point locations of the SRG components such that they appear to be at different locations on different layers. A perimeter of a given cell in the layer provides an overlap with neighboring cells in other layers to thereby model the effects from inter-layer coupling.

In an illustrative example, a simulation algorithm using the discretized grid-based waveguide model is configured to run in a similar manner to a neural network in which light (i.e., neurons) flows in the waveguide as a sequence of cellular interactions. Machine learning is not utilized, however, to determine weighted inputs to the network. Instead, the weights (and biases if used) are constant and initially determined at the beginning of simulation based on the spatial geometry defined by the grid structure and physical parameters of the waveguide and SRG coupling components. When a simulation is run, the flows are computed in a stepwise manner such that cells interact with neighboring cells in the waveguide, and so on, until a steady state is achieved. The simulation algorithm is computationally compact to save on computing resources and time because there is no need to model and simulate the exponential increase of rays that occurs with conventional ray tracing.

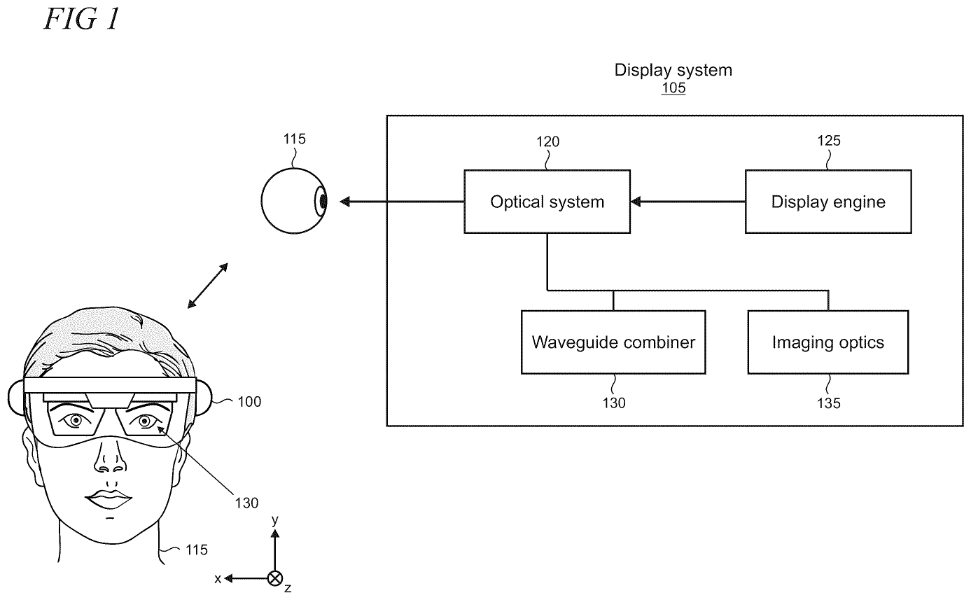

Turning now to the drawings, FIG. 1 shows a block diagram of an illustrative display system 105 incorporated into an HMD device 100 that is worn by a user 115. The display system includes an optical system 120 and a display engine 125. The optical system includes a waveguide-based optical combiner (referred to herein as a waveguide combiner 130) and typically includes magnifying and/or collimating optical components (referred to herein as imaging optics 135) to provide virtual images and real-world images. In this illustrative example, the waveguide combiner includes exit pupil expander (EPE) functionalities, as described below.

The display engine 125 in the display system 105 is a source of virtual-world objects or holographic images (collectively referred to herein as “virtual images”) that work with the optical system 120 to deliver virtual images as a display to a user's eye 115. The display engine is configurable, for example, using RGB (red, green, blue) light emitting diodes (LEDs) or lasers, LCoS (liquid crystal on silicon) devices, OLED (organic light emitting diode) arrays, MEMS (micro-electro-mechanical system) scanning devices, or any other suitable displays or micro-displays operating in transmission, reflection, or emission. The display engine is further configurable in some cases to include electronics such as processors, optical components such as mirrors and/or lenses, and/or mechanical and other components that enable a virtual display to be composed and to provide optical beams for the virtual images as an input to the optical system.

An individual instance of the display system 105 is typically provided for each respective eye of the user 115 in binocular HMD device applications. Separate display engines 125 and/or imaging optics 135 may also be utilized for each eye in binocular applications in some cases. Multi-color display systems may utilize a stack of multiple waveguide combiner plates in which a separate plate is used to guide virtual image light for a separate color component of virtual images generated by the display engine 125. While the simulation embodiments provided herein are illustrated with respect to a single waveguide combiner, it may be appreciated that the principles disclosed may be utilized in binocular and/or multi-plate waveguide combiner embodiments.

The display system 105 is configurable as a near-eye display in some applications. Near-eye display systems are often used, for example, in HMD devices in industrial, commercial, military, and consumer applications. In a near-eye display system, the display engine 125 does not actually shine the images on a surface such as a glass lens to create the visual display for the user. This is not feasible because the human eye cannot focus on something that is that close. Rather than create a visible image on a surface, the display system forms a pupil and the eye 115 acts as the last element in the optical chain and converts the light from the pupil into an image on the eye's retina as a virtual display. It may be appreciated that the exit pupil is a virtual aperture in an optical system. Only rays which pass through this virtual aperture can exit the system. Thus, the exit pupil describes a minimum diameter of the virtual image light after leaving the display system. The exit pupil defines the eyebox which comprises a spatial range of eye positions of the user in which the virtual images projected by the display system are visible.

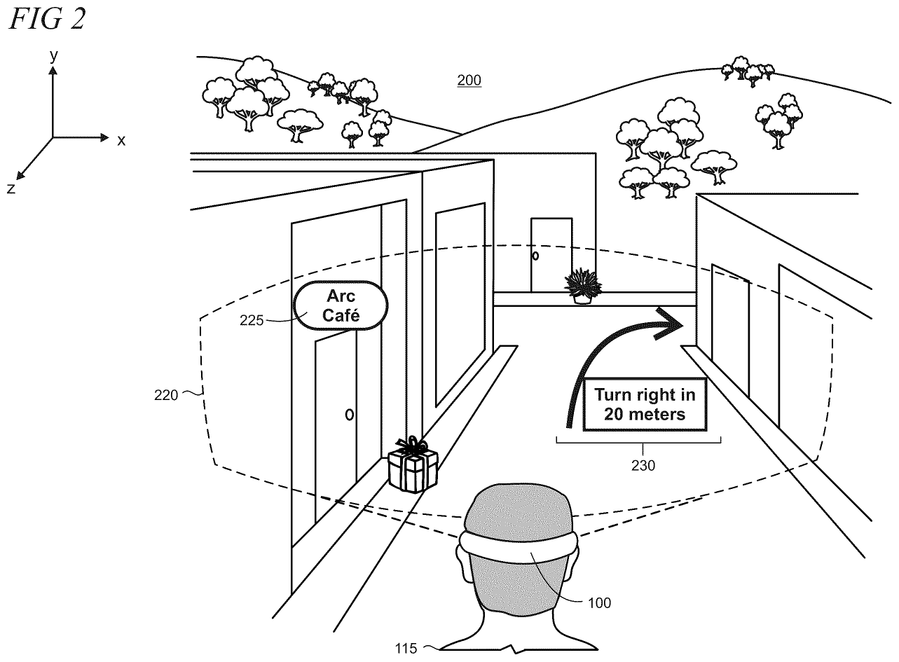

FIG. 2 shows the HMD device 100 worn by a user 115 as configured for mixed-reality experiences. As noted above, a display engine (not shown) generates virtual images that are guided by the waveguide in the display system to the user. Being see-through, the waveguide in the near-eye display system enables the user to perceive light from the real world. The near-eye display system renders images of various virtual objects that are superimposed over the real-world images that are collectively viewed using the see-through waveguide display to thereby create a mixed-reality environment 200 within the HMD device's FOV 220. It is noted that the FOV of the real world and the FOV of the images in the virtual world are not necessarily identical, as the virtual FOV provided by the near-eye display system is typically a subset of the real FOV. FOV is typically described as an angular parameter in horizontal, vertical, or diagonal dimensions.

It is noted that FOV is just one of many design parameters that are typically considered and balanced by HMD device designers to meet the requirements of a particular implementation. For example, such design parameters include eyebox size, brightness, transparency and duty time, contrast, resolution, color fidelity, depth perception, size, weight, form-factor, and user comfort (i.e., wearable, visual, and social), among others.

In the illustrative example shown in FIG. 2, the user 115 is physically walking in a real-world urban area that includes city streets with various buildings, stores, etc., with a countryside in the distance. The FOV of the cityscape viewed on HMD device 100 changes as the user moves through the real-world environment and the device can render static and/or dynamic virtual images over the real-world view. In this illustrative example, the virtual images include a tag 225 that identifies a restaurant business and directions 230 to a place of interest in the city. The mixed-reality environment 200 seen visually on the near-eye display system is also supplemented by audio and/or tactile/haptic sensations produced by the HMD device in some implementations.

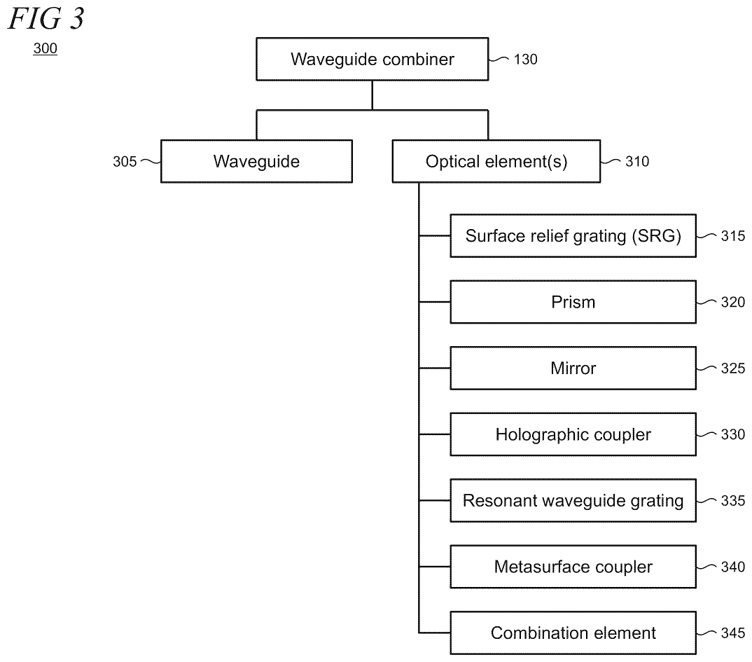

FIG. 3 shows a taxonomy 300 of illustrative components of the waveguide combiner 130. The waveguide combiner includes a transparent waveguide 305 and optical elements 310 that are configured to alter or steer the propagation of light in the waveguide. The optical elements may be configured in different types. The number of optical elements utilized to implement a given waveguide combiner is generally dependent on the element type. The optical elements comprise, by way of example and without limitation, surface relief gratings (SRGs) 315, prisms 320, mirrors 325 or other reflective optical elements, holographic couplers 330, resonant waveguide gratings (RWGs) 335, metasurface couplers 340, and combination elements 345 (e.g., buried holographic couplers combined with top and/or bottom SRGs). Other types of optical elements operating in either transmission or reflection mode may be utilized to meet the needs of a particular waveguide combiner application.

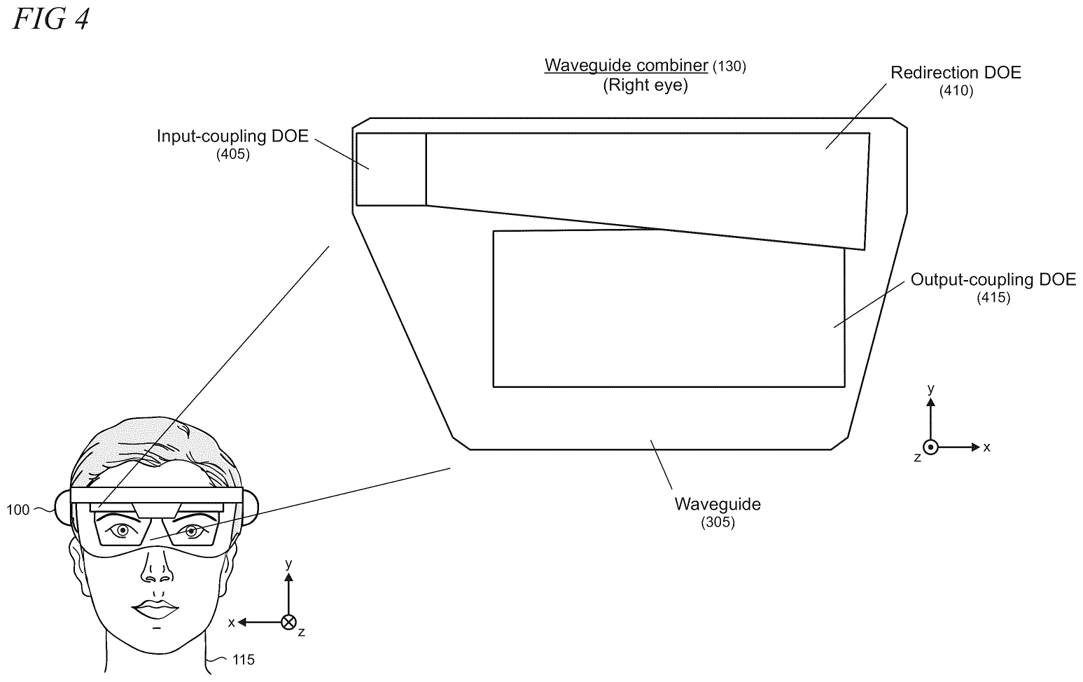

FIG. 4 shows an illustrative waveguide combiner 130 configured with optical elements comprising diffractive optical elements (DOEs) having surface relief grating (SRG) construction that are disposed on the transparent waveguide 305. The waveguide combiner shown in the drawing is provided for the right eye of the user 115. The waveguide combiner for the left eye (not shown) will typically utilize a similar configuration as that for the right eye.

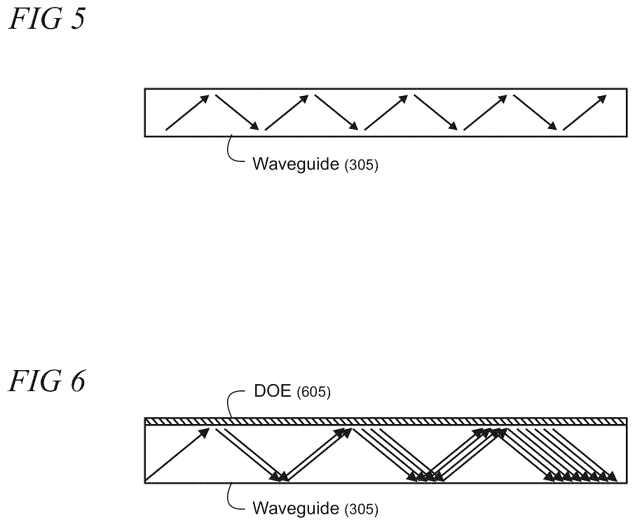

As shown in FIG. 5, the waveguide 305 operates using a principle of total internal reflection (TIR), as shown in the drawing, so that light can be coupled among the various optical elements in the display system. TIR is a phenomenon which occurs when a propagating light wave strikes a medium boundary (e.g., as provided by the optical substrate of a waveguide) at an angle larger than the critical angle with respect to the normal to the surface. In other words, the critical angle (θ_{c}) is the angle of incidence above which TIR occurs, which is given by Snell's Law, as is known in the art. More specifically, Snell's law specifies that the critical angle (θ_{c}) is specified using the following equation:

$${θ}_{c} = {sin}^{- 1} ( n 2 / n 1 )$$

where θ_{c} is the critical angle for two optical mediums (e.g., the waveguide substrate and air or some other medium that is adjacent to the substrate) that meet at a medium boundary, n1 is the index of refraction of the optical medium in which light is traveling towards the medium boundary (e.g., the waveguide substrate, once the light is coupled therein), and n2 is the index of refraction of the optical medium beyond the medium boundary (e.g., air or some other medium adjacent to the waveguide substrate).

Returning to FIG. 4, the DOEs utilized in this illustrative example of the waveguide combiner 130 include an input-coupling DOE 405, a redirection DOE 410 (also commonly referred to as an “intermediate” DOE), and an output-coupling DOE 415. The input-coupling DOE in-couples virtual image light from the display engine (via imaging optics) into the waveguide 305. The output-coupling DOE couples virtual light out of the waveguide to the user's eye. The redirection DOE couples light between the input-coupling and output-coupling DOEs. In this illustrative example, the redirection and output-coupling DOEs further operate to provide exit pupil expansion. For example, the redirection DOE expands the exit pupil in a first direction along a first coordinate axis (e.g., horizontal), and the output-coupling DOE expands the exit pupil in a second direction along a second coordinate axis (e.g., vertical) in addition to out-coupling virtual image light from the waveguide.

The DOEs in this illustrative example comprise a single input-coupling DOE 405 disposed on the waveguide 305 to the left of the redirection DOE 410, which is located above the output-coupling DOE 415. It is emphasized that such architecture is only exemplary and is not intended to be limiting. A variety of different architectures and arrangements of DOEs and/or other optical elements may be modeled for application of the present simulation techniques. For example, the input-coupling DOE may be centrally positioned within the waveguide and one or more intermediate DOEs can be disposed laterally from the input-coupling DOE, in a so-called “butterfly” configuration, to enable virtual image light to propagate to the left and right while providing for exit pupil expansion along the first direction.

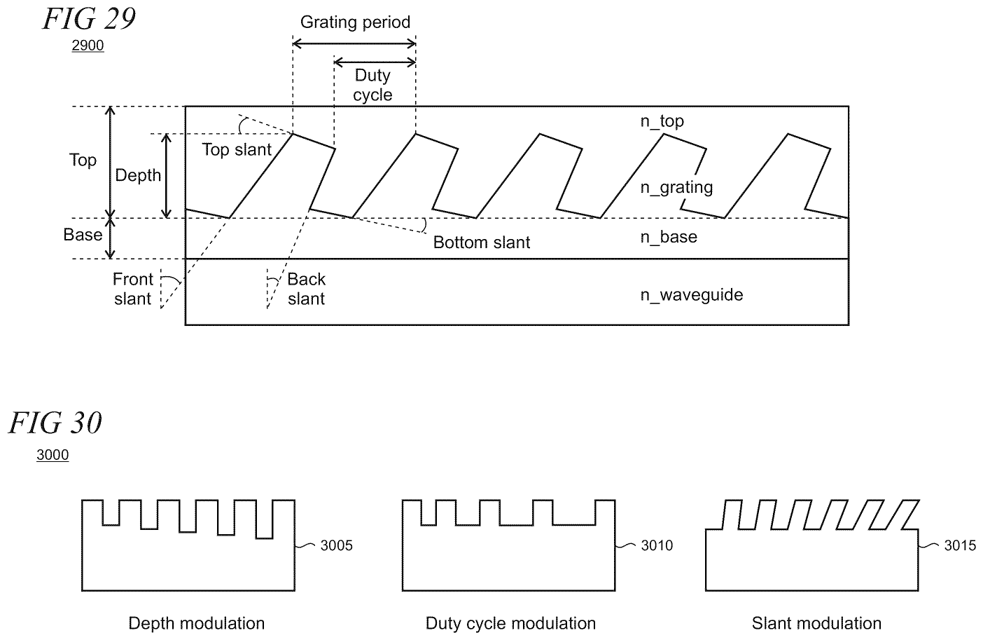

Parameters describing grating structures in the DOEs are typically optimized during the design process of the waveguide combiner 130 to meet various performance goals including, for example, FOV, color uniformity, efficiency, and modulation transfer function (MTF). Illustrative grating parameters are shown in FIGS. 29 and 30 and described in the accompanying text below.

One of the challenges faced by optical engineers and designers when attempting to simulate light propagation in waveguides is that conventional simulation techniques such as ray tracing utilize computations that take a long time to execute. As shown in FIG. 6, light rays propagating in TIR in the waveguide 305 “multiply” with each interaction (i.e., “hit”) with a DOE 605 disposed on the top of the waveguide. Therefore, the number of rays being traced grows exponentially as simulation computations are conducted. Even with the use of generous computing resources (e.g., 1,000 central processing unit (CPU) cores), a single ray-tracing simulation for a typical waveguide geometry can consume tens of minutes or more.

Multiple ray-tracing simulations can be combined in a design optimization technique using a genetic algorithm. This technique mimics biological processes of natural selection and evolution to enable comprehensive exploration of a waveguide combiner design space. Starting with an initial population, performance of each design is simulated and evaluated by application of a fitness function. The fittest designs are selected for reproduction by swapping and/or recombining values defining geometry, materials, characteristics, parameters, or other design properties to create new offspring designs. Random mutations (i.e., modifications) are introduced into the offspring designs to maintain diversity of the population and explore new regions in the design space. The offspring designs and some fittest individuals from the previous generation are selected to form a new population. The process is iterated to generate multiple generations of candidate designs until a target design is identified or a predetermined number of generations is reached.

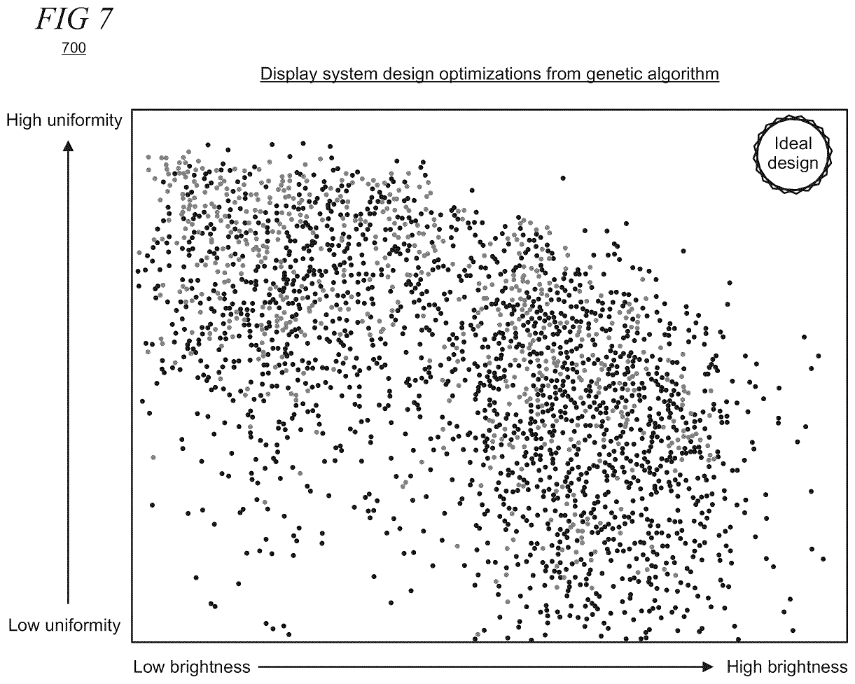

In the illustrative example shown in graph 700 in FIG. 7, multiple iterations of waveguide designs from application of a genetic algorithm are plotted for exemplary metrics of brightness and uniformity. An ideal design having high uniformity and brightness is located in the upper righthand corner of the graph. Each design iteration typically consumes thousands of simulations. Using conventional ray-tracing simulations, a full design cycle for a waveguide combiner can consume substantial computing resources over weeks and months of time.

The present discretized grid-based approach replaces conventional ray tracing in favor of a model in which the waveguide is viewed as a stack of layered cells in a grid and light is treated as a viscous liquid that crawls along layers from one cell to another. Thus, in some ways, the present approach has similarities to a cellular automaton model using a stack of two-dimensional grids. Using a sequential stepwise process, the state of each cell at each subsequent step is determined by a mathematical function that depends on the current state of the cell and states of its neighboring cells.

The grid-based approach to waveguide combiner design simulation is fundamentally different from conventional ray tracing which treats k-vectors, spatial coordinates, and time as continuous values. By comparison, the grid-based approach discretizes the k-vector space into bins. That is, the k-vector space is non-continuous. The waveguide is split into cells such that the applicable spatial coordinate system becomes non-continuous.

Simulation computations are carried out in sequential steps. Thus, time is also discretized. The amount of light X is defined in a grid cell i by a vector:

$${X}^{( i )} = {[ {x}^{( i , 1 )} , {x}^{( i , 2 )} , … , {x}^{( i , u )} , … , {x}^{( i , N )} ]}^{T} ,$$

having the element x(i,u). Here, the index u E {1, . . . , N} refers to a respective discretized k-vector space (or simply just the k-space)

$$K = {[ \begin{matrix}{k}_{x 1} , {k}_{x 2} , … , {k}_{xu} , … , {k}_{xN} \\ {k}_{y 1} , {k}_{y 2} , … , {k}_{yu} , … , {k}_{yN}\end{matrix} ]}^{T} .$$

The pair of kₓᵤ and k_{yu} are the k-space values of bin u. The k-space may be discretized in various ways.

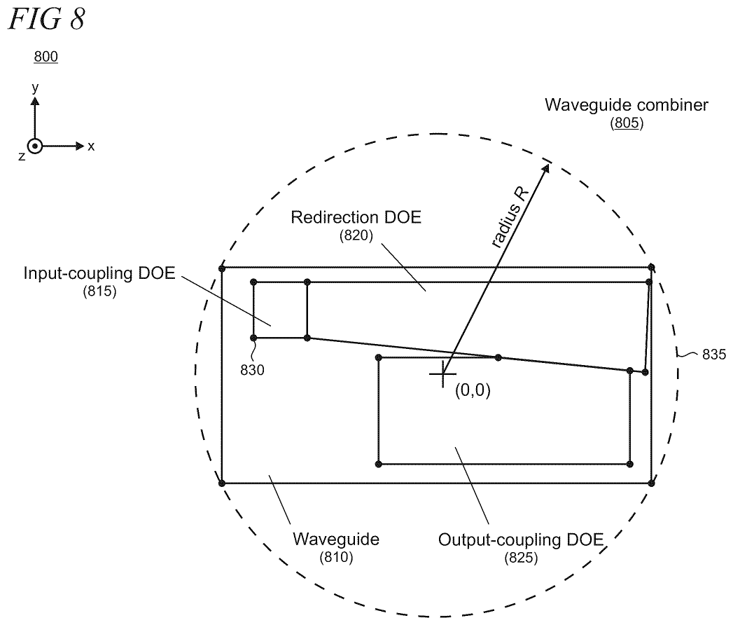

As shown in FIG. 8, the physical geometry 800 of a waveguide combiner of interest 805 is first defined. The definition includes the shape of the waveguide 810 and the locations of the SRG elements—DOEs 815, 820, and 825—using vertex points as representatively indicated by reference numeral 830. Additionally, SRG properties are defined, such as grating vector orientations, modulation depths, and fill factors. The waveguide should be positioned inside a circle 835 of radius R, with a global origin at the center.

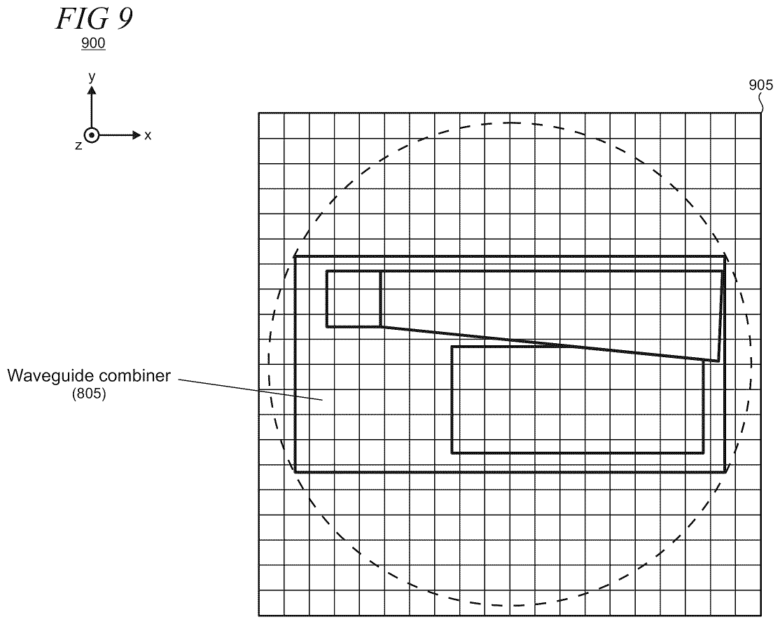

The waveguide 810 is modeled as a stack of two-dimensional surfaces without thickness (i.e., the waveguide thickness in the z direction equals zero), termed “layers.” Each layer is discretized into a grid of cells 900 as shown in FIG. 9 in which a grid structure 905 is superimposed over the waveguide. Continuing with the analogy of light as a viscous liquid, each cell may be understood as a cup or bucket with the capacity to store some liquid that represents the amount of virtual image light. In this illustrative example, the cells are provided as squares of equal size. However, other shapes and/or non-equal size cells are usable in alternative implementations of the present principles. It is noted that the terms light, energy, power, ray, liquid, and state are used somewhat interchangeably. To distinguish between them, light, energy, and power denote physical quantities, while ray refers to a conventionally computed beam of light. Liquid represents a mental image of the present light approximation, and state indicates the computed value of one memory element.

Unlike conventional ray tracing, individual rays of light are not modeled using the present approach. Instead, light is treated as an aggregate amount of optical power that resides in the area of a grid cell. Visualizing virtual image light as a liquid that it is sprinkled on a tilted surface of a waveguide layer, it flows along the direction of the tilt. As there are no rays in this visualization, there is no need for ray tracing in the traditional sense. Instead of ray propagation, the light flows, or leaks, from one cell to another. The flow is computed in a stepwise manner, and the algorithm resembles a cellular automaton, where cells interact with their neighbors, as noted above.

In the physical world, each ray propagates in a direction that is conventionally described with a k-vector. The present grid-based approach deals with propagation in these different directions by discretizing the k-vector space into bins and designating each bin to a respective waveguide layer. That is, each bin (or k-vector) has its own waveguide surface, and therefore, light may propagate only in a specific direction in one layer. Using a transformation of the geometry defined for the waveguide combiner, virtual image light beam altering by the SRG components may be modeled by a grid-based waveguide model as light leaking energy from one layer to another.

Typically, the present simulation computations use an N×N size matrix to store the states of cells. Each cell has its respective connections to neighbors and, if it is part of an SRG element, couplings between layers. A cell at row i and column j on layer u is referenced as (i,j,u). The waveguide combiner geometry 800 is rotated so that light propagates in the same direction at all layers. In practice, the light is set to propagate only in the vertical or horizontal direction, depending on the programming language used and the CPU (or equivalent) and memory architectures that are available.

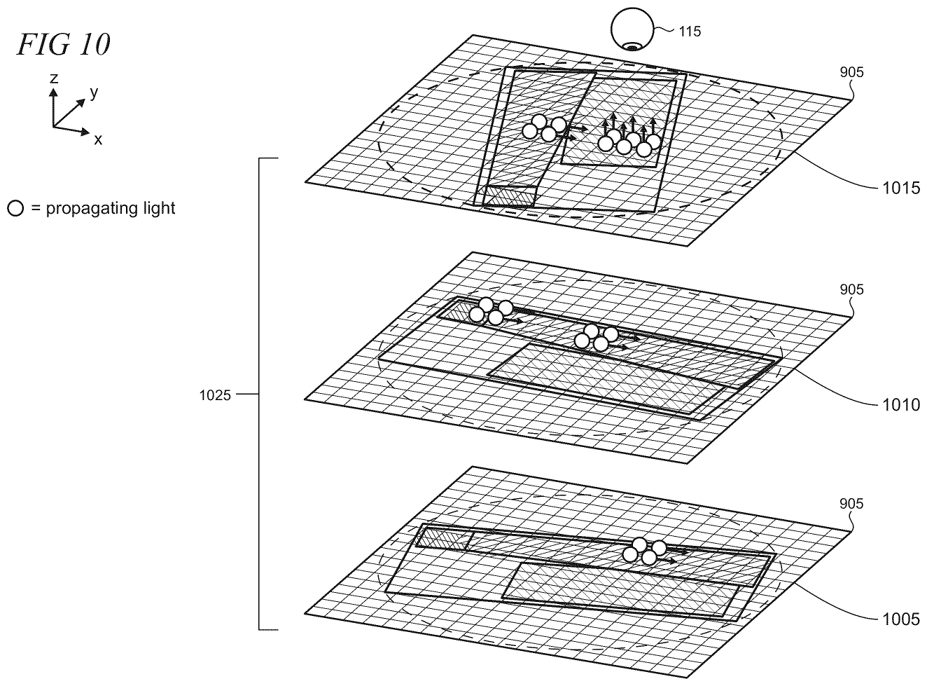

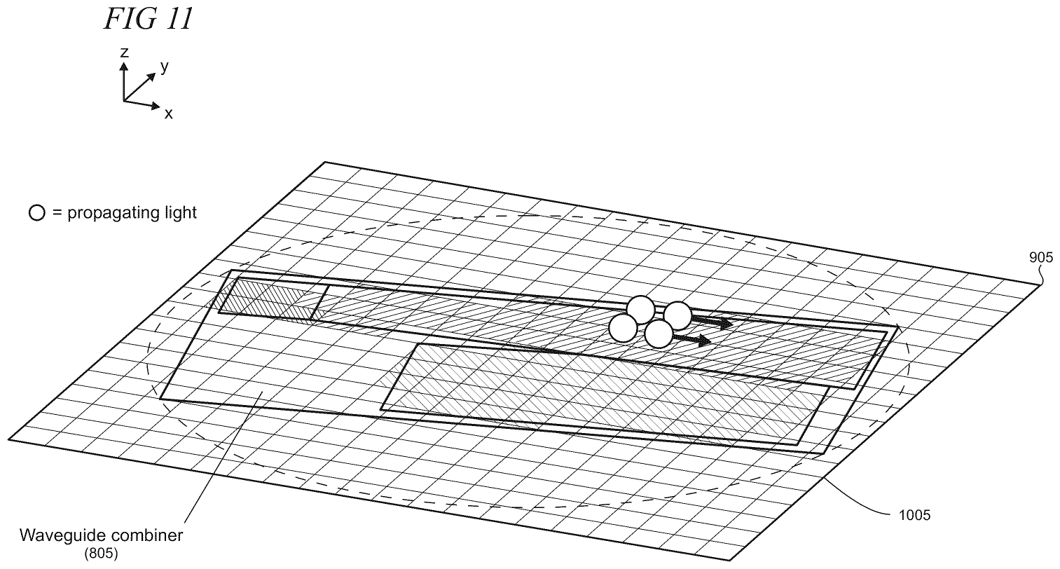

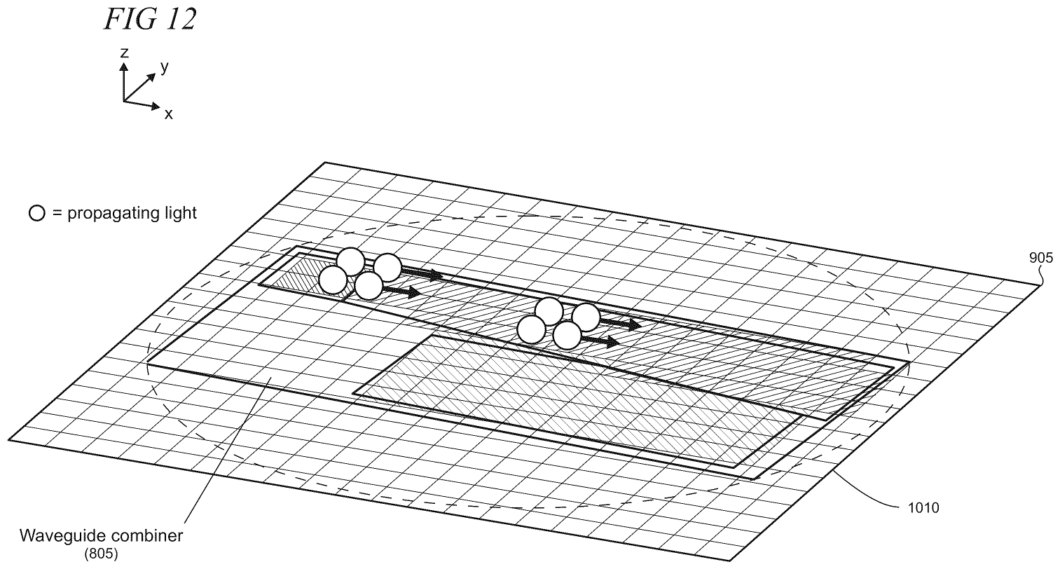

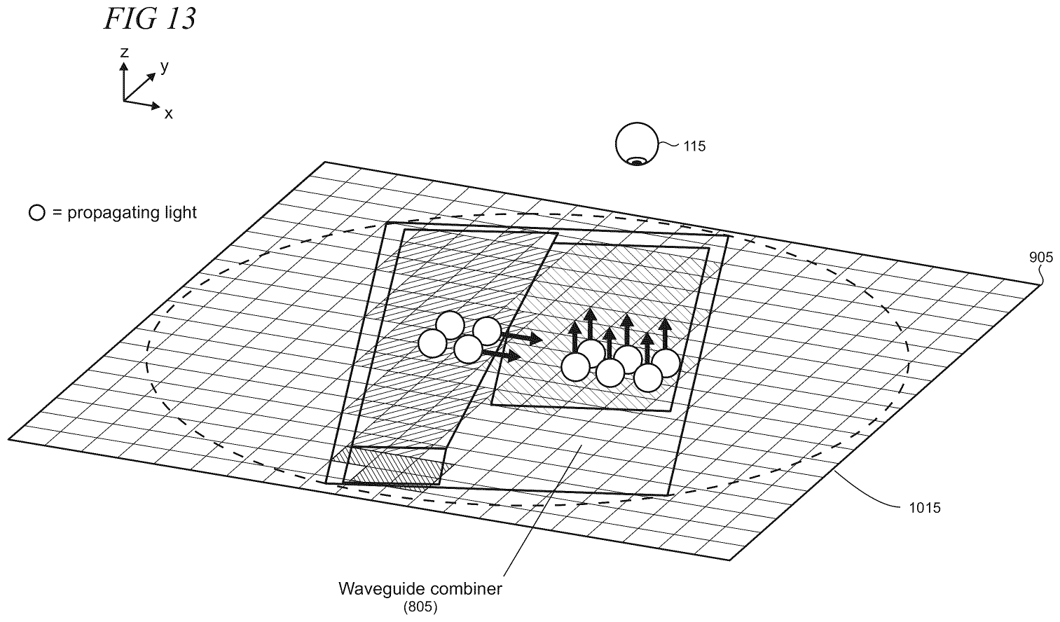

The rotation of three exemplary layers 1005, 1010, and 1015 in a stack 1025 are shown in FIG. 10 (the layers are individually shown in enlarged view in FIGS. 11, 12, and 13). In layers 1005 and 1010, virtual image light (symbolized using white circles in the drawings) propagates from left to right in the xy plane. In layer 1015, virtual image light propagates from left to right in the xy plane and is out-coupled in the z direction towards the eye of the user 115.

As shown in FIGS. 10-13, the rotation of the geometry 800 of the waveguide combiner naturally changes the vertex point locations of the DOEs such that they appear to be at different locations on different layers. Using mathematical notation, a vertex point (x,y)^{T} will rotate to (x′,y′)^{T}=R_{ϕ} (x,y)^{T}, where R_{ϕ} is the rotation matrix that depends on the azimuth angleϕ=atan(k_{y}/kₓ) of the k-vector bin.

The added complexity resulting from the rotated geometries is compensated for by simplified and speedy computation of light propagation. The cell (i,j,u) has only single intra-layer input and output connections with the same row cells j−1 and j+1, respectively. The computation may be done efficiently because the light propagation is just a multiplication of two scalars. The amount of arriving light x^{(i,j,u)} is proportional to the state of the same row preceding cell j−1 as: x^{(i,j,u)}=x^{(i,j-1,u)}w_{(i,j-1,u)} where the weight w_{(i,j-1,u)} takes into account the propagation loss between the cells and the potential loss of light due to coupling to other layers from the cell j−1.

The purpose of a DOE in the waveguide combiner is to diffract light into new directions of propagation. In terms of the k-vector space, and here, the k-vector bins and their respective waveguide layers, the DOE will translate a portion of light from cell (i,j,u) into the multiple cells and layers (a,b,v). Because the layer u vertices are rotated by its k-vector azimuth angle ϕᵤ and layer v vertices by azimuth angle ϕᵥ, the physical (non-rotated) perimeter of cell (i,j,u) will likely overlap multiple cells (a₁,b₁) at layer v₁ and some other multiple cells (a₂, b₂) at layer v₂. Thus,

$${x}^{( i , j , u )} = {\sum }_{v \neq u} {\sum }_{a , b} {x}^{( a , b , v )} {p}_{( i , j , u )}^{( a , b , v )} ,$$

where x^{(a,b,v)} are the states of cells (a,b) of layers v and

$${p}_{( i , j , u )}^{( a , b , v )}$$

are the coupling strengths from cells (a,b) of layers v to cell (i,j) of layer u. It is also noted that the coupling is generally not reciprocal in strength, i.e.,

$${p}_{( i , j , u )}^{( a , , b , v )} \neq {p}_{( a , , b , v )}^{( i , j , u )} .$$

In an illustrative example, the present grid-based simulation techniques are implemented as a neural network model but, unlike conventional neural networks, the model here does not require machine learning to determine weights. Instead, the weights are predetermined based on physical and geometrical rules. Simulation computations proceed step-by-step and are terminated once a steady state is reached. The state x of cell (i,j) of layer u at the computation step m is calculated as follows. The input state is composed of three terms: the intralayer (neighbor), inter-layer, and external input

$${x}_{m}^{( i , j , u )} = {\underbrace{{x}_{m - 1}^{( i , j - 1 , u )} {w}_{( i , j - 1 , u )}}}_{intralayer} + {\underbrace{{\sum }_{v} {\sum }_{a , b} {x}_{m - 1}^{( a , b , v )} {p}_{( a , b , v )}^{( i , j , u )}}}_{inter - layer} + {\underbrace{{c}_{m}^{( i , j , u )}}}_{external input}$$

where

$${c}_{m}^{( i , j , u )}$$

is the external input. Note that the coupling strength

$${p}_{( a , b , v )}^{( i , j , u )}$$

refers to the feed-forward direction from the cells (a,b,v) to the cell (i,j,u); that is, from potentially many to one.

In the following, the cells (i,j,u) and (a,b,v) are addressed many times. For clarity, these cells are referred to using shorthand (i) and (a), respectively. There are two options for the external input

$${c}_{m}^{( i )} :$$

a. The external input

$${c}_{m}^{( i )}$$

can either be considered a constant, i.e., ∀m,

$${c}_{m}^{( i )} = {bias}^{( i )} ,$$

thus making it the bias of the neural network.
b. Alternatively, the external input

$${c}_{m}^{( i )}$$

can be used as an excitation (an impulse) of the network as

$${c}_{m}^{( i )} = \{ \begin{matrix}{c}^{( i )} , & m = 1 \\ 0 , & m > 1\end{matrix} .$$

If the external input will be used as the impulse, i.e., an excitation of the network, then light intensity that is output from the system must be tracked at each time step, for example, by collecting intensity data in an array of size N×C, i.e., one value per k-space bin and waveguide grid cell. This array then directly gives the efficiency numbers of output per FOV angle. Furthermore, the computation steady-state criterion is now defined by setting a threshold for remaining intensity in the system.

The neighbor connecting weight w is usually close to one, save some reduction due to propagation loss and couplings to other layers as

$${w}_{( i )} = 1 - {loss}_{u} - {\sum }_{v} {\sum }_{a} {p}_{( i )}^{( a )} ,$$

where lossᵤ is the propagation loss of layer u. In distinction from the input state calculation, here, the coupling strength p is observed at the cell (i) output, switching the order of the sub and superscripts. Also, one should note that the cells (a) are naturally not the same as when calculating the input state. As stated earlier, the network is in the feed-forward arrangement.

Determining the lossᵤ can be straightforward as it depends on material properties and surface losses. It may be assumed that the losses are higher for k-vectors close to the critical angle than for k-vectors close to the grazing angle.

The coupling strength is defined as

$${p}_{( i )}^{( a )} = {d}_{( i )}^{( v )} \cdot {r}_{( i )}^{( a )} ,$$

where

$${d}_{( i )}^{( v )}$$

is the diffraction from cell (i) to the entirety of layer (v), and

$${r}_{i}^{( a )}$$

is the proportion that cell (i) area is covered by cell (a)

$${r}_{( i )}^{( a )} = {A}_{( i )}^{( a )} / {A}^{( i )} ,$$

where A⁽ⁱ⁾ is the cell (i) surface area and

$${A}_{i}^{( a )}$$

is the overlap area between the cells (a) and (i). Importantly, it is assumed that

$${r}_{( i )}^{( a )} \neq {r}_{( a )}^{( i )} .$$

As explained earlier, although the cells on different layers do have equal size in this illustrative embodiment, cell sizes can vary in shape and size in alternative implementations. Therefore, the algorithm is typically implemented such that overlap ratios are not assumed to be the same.

Note that that the coupling strengths p, losses, and weights w remain constant and are calculated once at the beginning of the simulation. The same applies also to the biases c=bias if they are used.

The overlap area

$${A}_{i}^{( a )}$$

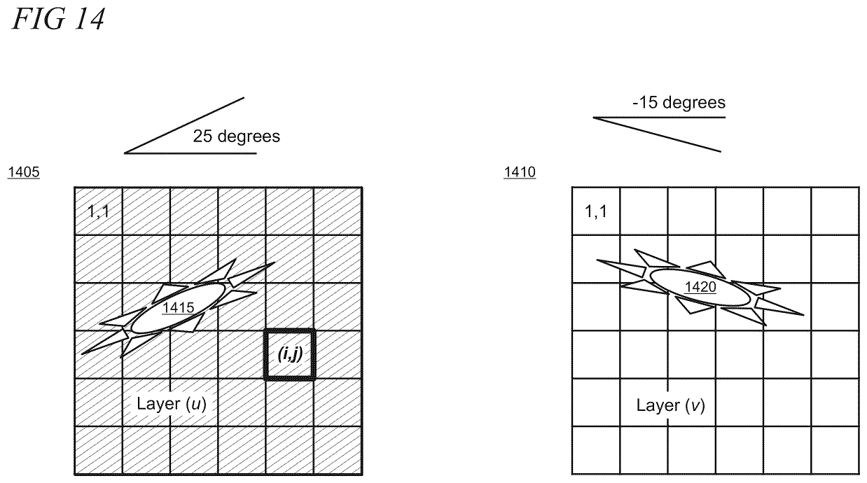

between the cells (a,b,v) and (i,j,u) can be calculated as follows. The layers u and v have their associated k-vectors and respective azimuth angles ϕᵤ and ϕᵥ. As shown in FIG. 14, two layers u and v (respectively indicated by reference numerals 1405 and 1410) depict some vertex points 1415 and 1420 rotated along the respective azimuth angles of 25 degrees and −15 degrees around the origin (centers of matrices).

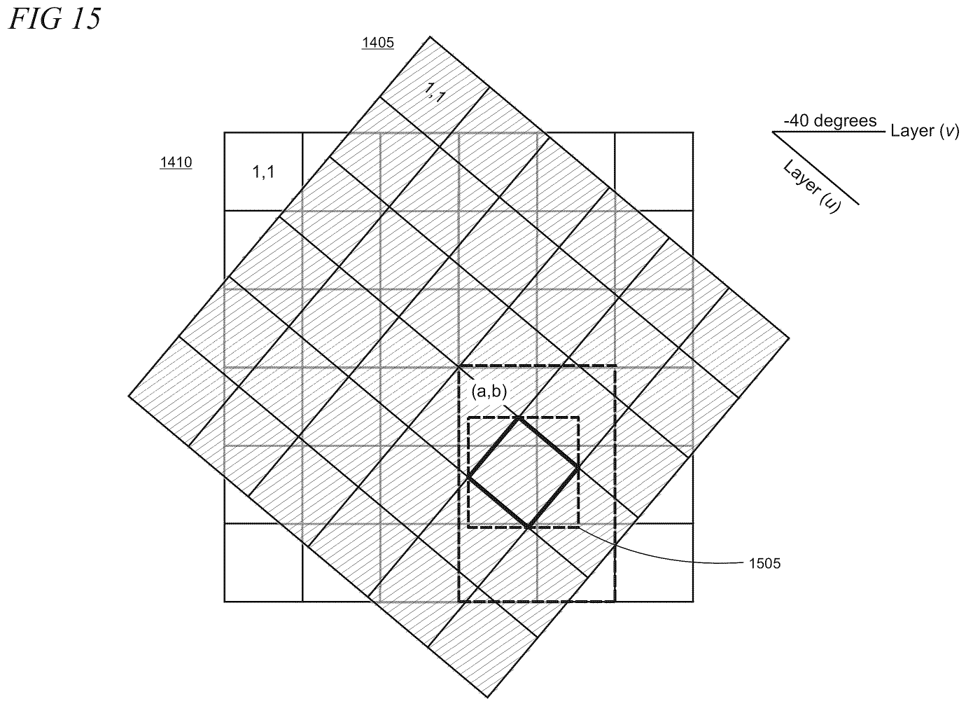

A first step is to rotate the layer (u) grid points by angle ρ=ϕᵥ−ϕᵤ and determine cell (i,j) bounding box in layer (v)-coordinates. The bounding box limits are simply the maximum and minimum values of the cell vertices along the x and y dimensions as marked with the dashed rectangle indicated by reference numeral 1505 in FIG. 15. Using the limits

$$[ {x}_{min}^{( i \to v )} , {x}_{max}^{( i \to v )} , {y}_{min}^{( i \to v )} , {y}_{max}^{( i \to v )} ] ,$$

potentially overlapping cells of layer (v) may be determined, which in this case are [(a,b), (a+1,b), (a+2,b), (a,b+1), (a+1, b+1), (a+2, b+1)]. Using some appropriate library, such as Shapely or NetTopologySuite (NTS) in Python or C#, respectively, the overlap areas

$$[ {A}_{( i , j )}^{( a , b )} , {A}_{( i , j )}^{( a + 1 , b )} , {A}_{( i , j )}^{( a + 2 , b )} , {A}_{( i , j )}^{( a , b + 1 )} , {A}_{( i , j )}^{( a + 1 , b + 1 )} , {A}_{( i , j )}^{( a + 2 , b + 1 )} ]$$

and the ratios

$${r}_{( i )}^{( a )}$$

are readily determined. It is noted that the bounding box is wider than the actual cell and some cells may not overlap the cell (i).

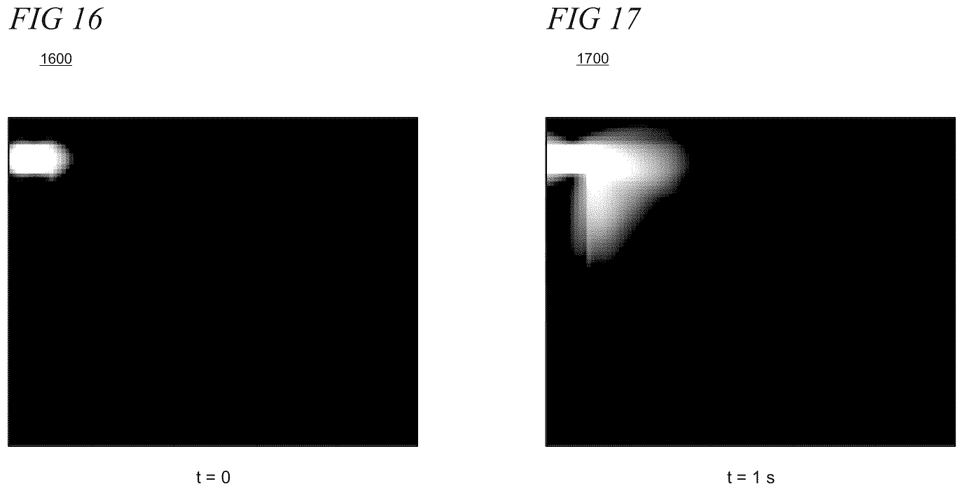

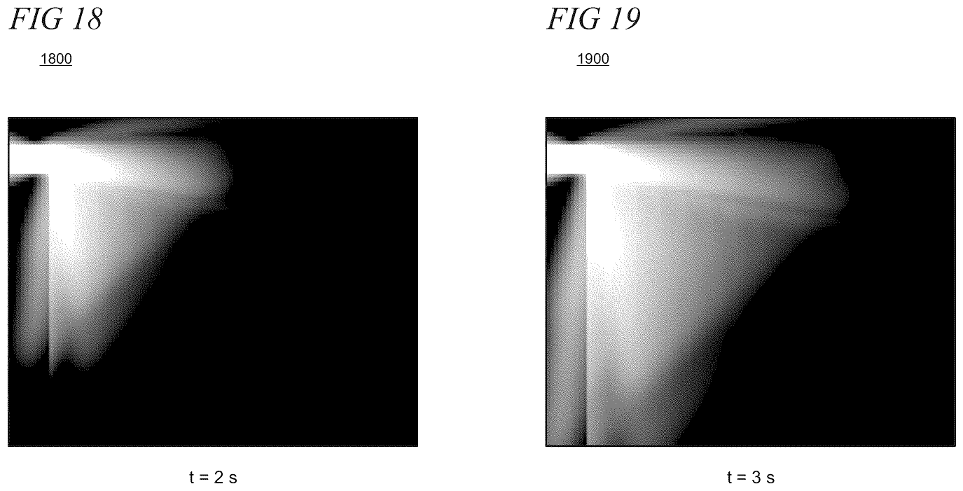

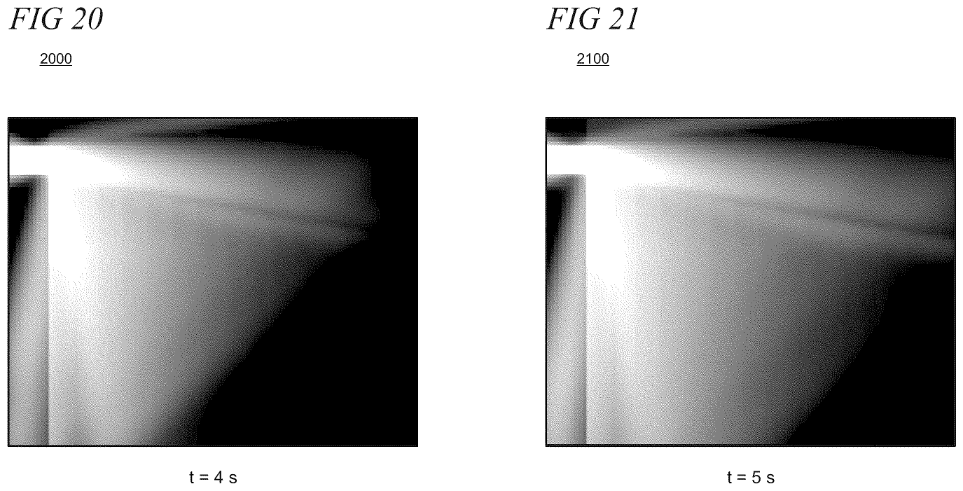

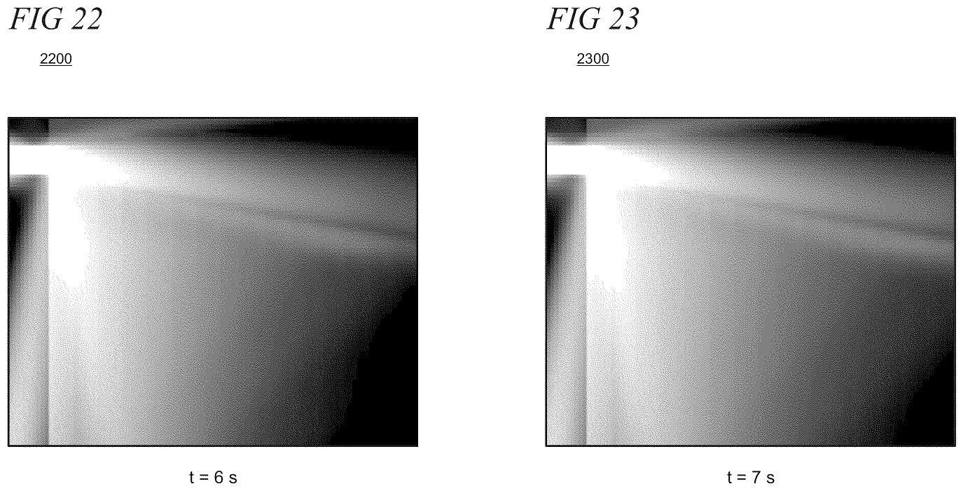

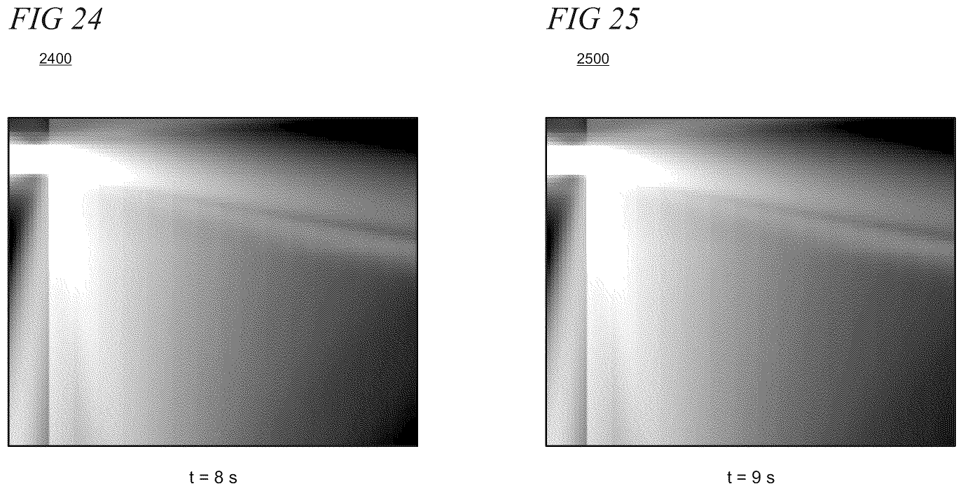

FIGS. 16-25 show respective screen-captures 1600, 1700, 1800, 1900, 2000, 2100, 2200, 2300, 2400, and 2500 taken at one-second intervals of an illustrative grid-based simulation of virtual image light propagation in a waveguide combiner based on the principles disclosed above. As graphically illustrated in the sequence of screen-captures, virtual image light from the display engine is in-coupled at the top left corner of the waveguide and then smoothly propagates downwards and to the right in the waveguide. In this illustrative example, the simulation reaches a steady state in less than 10 seconds.

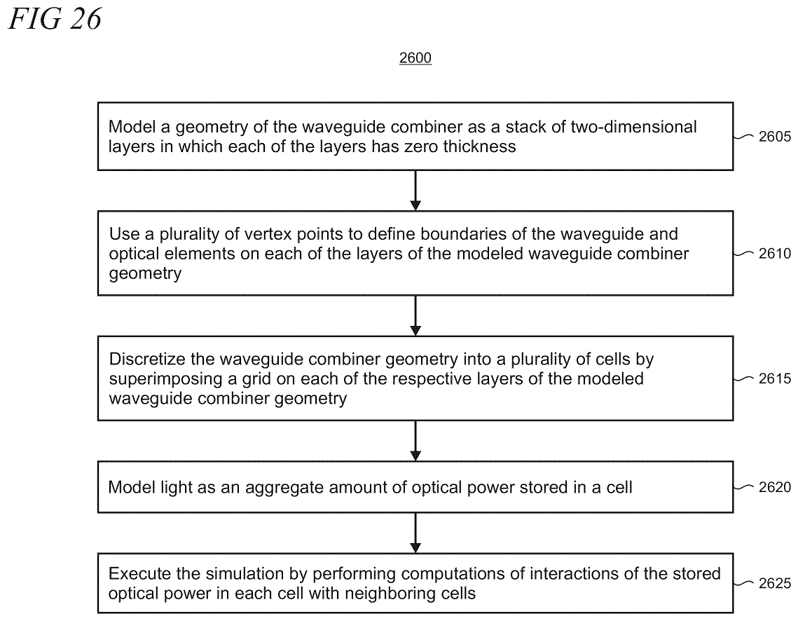

FIG. 26 is a flowchart of an illustrative method 2600 for executing a simulation for light propagation in a waveguide combiner comprising a transparent waveguide and one or more optical elements that alter the light propagation. Unless specifically stated, the methods or steps shown in the flowcharts and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

Block 2605 includes modeling a geometry of the waveguide combiner as a stack of two-dimensional layers in which each of the layers has zero thickness. Block 2610 includes using a plurality of vertex points to define boundaries of the waveguide and optical elements on each of the layers of the modeled waveguide combiner geometry.

Block 2615 includes discretizing the waveguide combiner geometry into a plurality of cells by superimposing a grid on each of the respective layers of the modeled waveguide combiner geometry. Block 2620 includes modeling light as an aggregate amount of optical power stored in a cell. Block 2625 includes executing the simulation by performing computations of interactions of the stored optical power in each cell with neighboring cells.

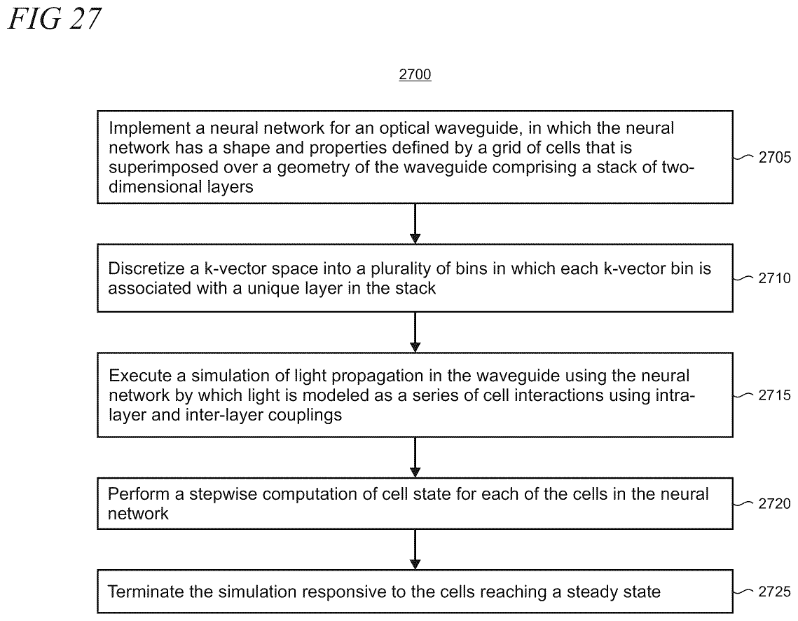

FIG. 27 is a flowchart of an illustrative method 2700 performed by a processor in a computing device when executing instructions stored on one or more hardware-based non-transitory computer-readable memory devices. Block 2705 includes implementing a neural network for an optical waveguide, in which the neural network has a shape and properties defined by a grid of cells that is superimposed over a geometry of the waveguide comprising a stack of two-dimensional layers.

Block 2710 includes discretizing a k-vector space into a plurality of bins in which each k-vector bin is associated with a unique layer in the stack. Block 2715 includes executing a simulation of light propagation in the waveguide using the neural network by which light is modeled as a series of cell interactions using intra-layer and inter-layer couplings.

Block 2720 includes performing a stepwise computation of cell state for each of the cells in the neural network. Block 2725 includes terminating the simulation responsive to the cells reaching a steady state.

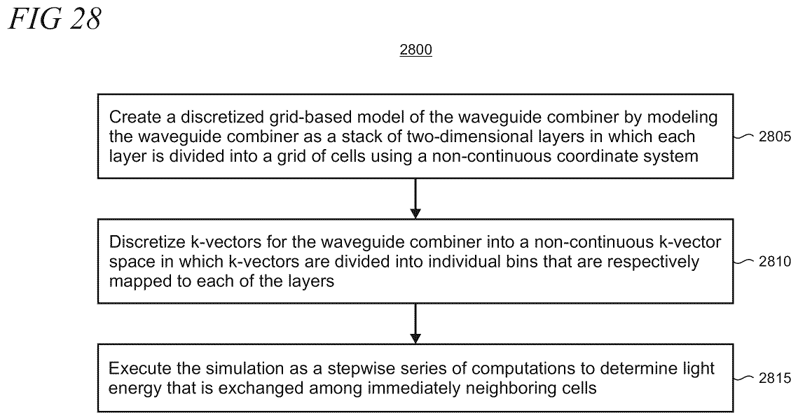

FIG. 28 is a flowchart of an illustrative method 2800 performed by a processor in a computing device when executing instructions stored on one or more hardware-based non-transitory computer-readable memory devices for implementing a simulation of light propagation in a waveguide combiner including a waveguide on which surface relief gratings are disposed.

Block 2805 includes creating a discretized grid-based model of the waveguide combiner by modeling the waveguide combiner as a stack of two-dimensional layers in which each layer is divided into a grid of cells using a non-continuous coordinate system.

Block 2810 includes discretizing k-vectors for the waveguide combiner into a non-continuous k-vector space in which k-vectors are divided into individual bins that are respectively mapped to each of the layers. Block 2815 includes executing the simulation as a stepwise series of computations to determine light energy that is exchanged among immediately neighboring cells.

FIG. 29 shows various illustrative design parameters that may be varied to implement desired characteristics in a DOE 2900 that is constructed using SRGs. An SRG is typically fabricated using lithographic techniques including, for example, nano-imprint lithography (NIL) which enables the topological structure of gratings to be optimized to achieve desired functionality in terms of both spectral and angular performance dimensions. The angular bandwidth of an SRG (i.e., the FOV that can be processed) can typically be tuned by optimizing the various parameters of the grating features. These include, for example, front and back slant angles, grating fill factor (i.e., the ratio of the grooves to the total period of the grating), coatings such as metallized coatings, grating depth, and grating period. Additional material variables include the refractive indices of the grating structure, grating base, grating top layer, grating coating, and underlying waveguide. It may be appreciated that the above-described design parameters can generally be applied to various types of gratings including, for example, binary, multilevel, blazed, and slanted.

FIG. 30 shows various illustrative modulation schemes 3000 for the DOE 2900. These include depth modulation 3005, duty cycle modulation 3010, and slant modulation 3015 which can be used as additional optimizations of grating structures. Such optimizations may be utilized, for example, to increase angular bandwidth over a large and uniform eyebox.

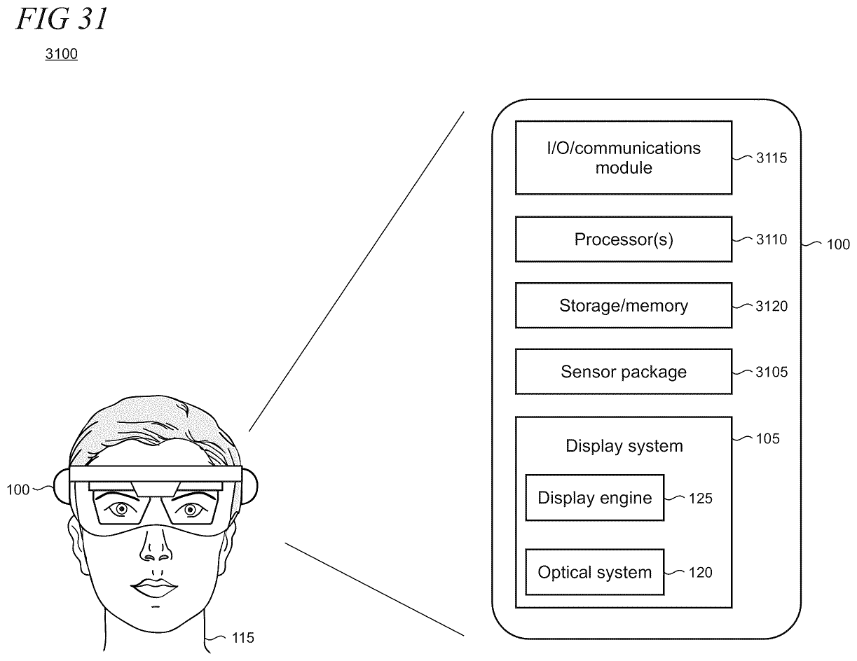

FIG. 31 is a functional block diagram 3100 of the illustrative HMD device 100. The HMD device includes the display system 105 comprising an optical system 120 and a display engine 125, as described above. The HMD device further comprises a sensor package 3105 that may comprise devices such as cameras, microphones, biometric and depth sensors, and the like to facilitate implementation of various features and capabilities in the HMD device including, for example, gaze and body tracking, position and motion sensing, and the like.

The HMD device 100 further includes one or more processors 3110. An input/output (I/O) and communications system module 3115 facilitates the HMD device being operated in conjunction with remotely located resources, such as processing, storage, power, data, and services. That is, in some implementations, an HMD device is operable as part of a system that distributes resources and capabilities among different components and systems.

Storage and memory system 3120 includes instructions stored thereon that are executable by the processors 3110. The storage system includes hardware storage devices, such as RAM, ROM, EEPROM, CD-ROM, DVD-ROM, solid state drives (SSDs) that are based on RAM, Flash memory, phase-change memory (PCM), or other types of memory, or other optical disk storage, magnetic disk storage or other magnetic storage devices, or any other medium that can be used to store desired program code in the form of computer-executable instructions, data, or data structures and that can be accessed as required for the HMD device to implement the various features and functionality described herein.

It may be appreciated that the HMD device 100 is described for the purpose of example, and thus is not meant to be limiting. It may be further understood that the HMD device includes, in some embodiments, additional and/or alternative sensors, cameras, microphones, input devices, output devices, etc. than those shown without departing from the scope of the present arrangement. Additionally, the physical configuration of an HMD device and its various sensors and components may take a variety of different forms without departing from the scope of the present arrangement.

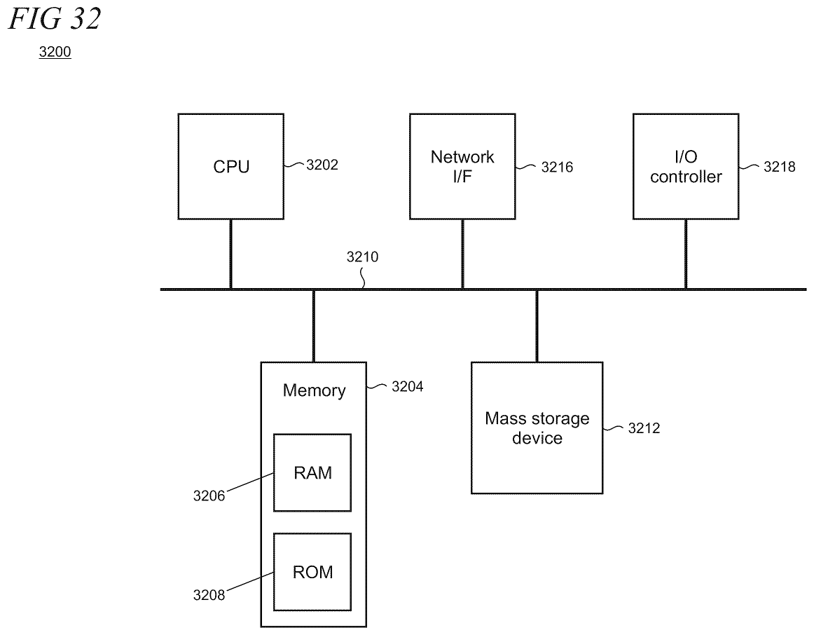

FIG. 32 is a simplified block diagram of an illustrative computing device architecture 3200 that may be used, at least in part, to implement aspects of the present fast grid-based simulations of waveguides with SRGs. For example, the architecture may be applicable to a computing device that is configured to execute computer-based simulations of waveguides in accordance with the present principles. The architecture 3200 includes one or more processors 3202 (e.g., central processing unit, dedicated AI (artificial intelligence) chip, graphics processing unit, etc.), a system memory 3204, including RAM (random access memory) 3206 and ROM (read only memory) 3208, and a system bus 3210 that operatively and functionally couples the components in the architecture 3200. A basic input/output system containing the basic routines that help to transfer information between elements within the architecture 3200, such as during startup, is typically stored in the ROM 3208. The architecture 3200 further includes a mass storage device 3212 for storing software code or other computer-executed code that is utilized to implement applications, a file system, and an operating system (OS). The mass storage device 3212 is connected to the processor 3202 through a mass storage controller (not shown) connected to the bus 3210. The mass storage device 3212 and its associated computer-readable storage media provide non-volatile storage for the architecture 3200. Although the description of computer-readable storage media contained herein refers to a mass storage device, such as an HDD (hard disk drive) or CD (compact disc) drive, it may be appreciated by those skilled in the art that computer-readable storage media can be any available storage media that can be accessed by the architecture 3200.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray or other optical storage, magnetic cassettes, magnetic tape, magnetic disk storage or other magnetic storage devices, or any other medium which can be used to store the desired information and which can be accessed by the architecture 3200.

According to various embodiments, the architecture 3200 may operate in a networked environment using logical connections to remote computers through a network. The architecture 3200 may connect to the network through a network interface unit 3216 connected to the bus 3210. It may be appreciated that the network interface unit 3216 also may be utilized to connect to other types of networks and remote computer systems. The architecture 3200 also may include an input/output controller 3218 for receiving and processing input from a number of other devices, including a keyboard, mouse, touchpad, touchscreen, and control devices such as buttons and switches or electronic stylus (not shown in FIG. 32). Similarly, the input/output controller 3218 may provide output to a display screen, user interface, a printer, or other type of output device (also not shown in FIG. 32).

It may be appreciated that the software components described herein may, when loaded into the processor 3202 and executed, transform the processor 3202 and the overall architecture 3200 from a general-purpose computing system into a special-purpose computing system customized to facilitate the functionality presented herein. The processor 3202 may be constructed from any number of cores, transistors, or other discrete circuit elements, which may individually or collectively assume any number of states. More specifically, the processor 3202 may operate as a finite-state machine, in response to executable instructions contained within the software modules disclosed herein. These computer-executable instructions may transform the processor 3202 by specifying how the processor 3202 transitions between states, thereby transforming the transistors or other discrete hardware elements constituting the processor 3202.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 3200 in order to store and execute the software components presented herein. It also may be appreciated that the architecture 3200 may include other types of computing devices, including wearable devices, handheld computers, embedded computer systems, smartphones, PDAs (personal digital assistants), and other types of computing devices known to those skilled in the art. It is also contemplated that the architecture 3200 may not include all of the components shown in FIG. 32, may include other components that are not explicitly shown in FIG. 32, or may utilize an architecture completely different from that shown in FIG. 32.

Various exemplary embodiments of the present fast grid-based simulations of waveguides with surface relief gratings are now presented by way of illustration and not as an exhaustive list of all embodiments. An example includes a method for executing a simulation for light propagation in a waveguide combiner comprising a transparent waveguide and one or more optical elements that alter the light propagation, the method comprising: modeling a geometry of the waveguide combiner as a stack of two-dimensional layers, each of the layers having zero thickness; using a plurality of vertex points to define boundaries of the waveguide and optical elements on each of the layers of the modeled waveguide combiner geometry; discretizing the waveguide combiner geometry into a plurality of cells by superimposing a grid on each of the respective layers of the modeled waveguide combiner geometry; modeling light as an aggregate amount of optical power stored in a cell; and executing the simulation by performing computations of interactions of the stored optical power in each cell with neighboring cells.

In another example, the neighboring cells share a common layer. In another example, the neighboring cells are in different layers. In another example, light is modeled as propagating in a common direction and the waveguide combiner geometry is rotated when computing interactions among cells in different layers. In another example, the method further includes rotating the waveguide combiner geometry. In another example, the computations are performed stepwise. In another example, the method further includes defining properties of the optical elements. In another example, the cells are each uniformly rectangular. In another example, the one or more optical elements include diffractive optical elements. In another example, the properties of the diffractive optical elements include one or more of grating vector orientation, refractive index, grating depth, duty cycle, grating period, depth modulation, duty cycle modulation, slant angle modulation, or fill factor. In another example, the one or more optical elements each have a type comprising one of surface relief grating, reflective optical element, holographic coupler, resonant waveguide gratings, metasurface couplers, or a combination of types.

A further example includes one or more hardware-based non-transitory computer-readable memory devices storing computer-executable instructions which, upon execution by a processor in a computing device, cause the computing device to: implement a neural network for an optical waveguide, the neural network having a shape and properties defined by a grid of cells that is superimposed over a geometry of the waveguide comprising a stack of two-dimensional layers; discretize a k-vector space into a plurality of bins in which each k-vector bin is associated with a unique layer in the stack; execute a simulation of light propagation in the waveguide using the neural network by which light is modeled as a series of cell interactions using intra-layer and inter-layer couplings; perform a stepwise computation of cell state for each of the cells in the neural network; and terminate the simulation responsive to the cells reaching a steady state.

In another example, intra-layer couplings comprise each cell in a layer having a single input and a single output. In another example, the inter-layer couplings comprise a portion of light determined by rotation of k-vectors in a bin in a layer to determine overlapping cells in adjacent layers, and in which the executed instructions further cause the computing device to compute a state for overlapping cells based on a coupling strength. In another example, the inter-layer couplings are provided by diffractive optical elements disposed on or in the waveguide. In another example, weights for the neural network are based on physical characteristics and geometry of the waveguide without utilization of machine learning, and weights are held constant during execution of the simulation.

A further example includes a computing device, comprising a processor and one or more hardware-based non-transitory computer-readable memory devices storing computer-executable instructions which, upon execution by the processor, cause the computing device to implement a simulation of light propagation in a waveguide combiner including a waveguide on which surface relief gratings are disposed, comprising: creating a discretized grid-based model of the waveguide combiner by modeling the waveguide combiner as a stack of two-dimensional layers in which each layer is divided into a grid of cells using a non-continuous coordinate system; discretizing k-vectors for the waveguide combiner into a non-continuous k-vector space in which k-vectors are divided into individual bins that are respectively mapped to each of the layers; and executing the simulation as a stepwise series of computations to determine light energy that is exchanged among immediately neighboring cells.

In another example, the immediately neighboring cells comprise inter-layer cells and intra-layer cells. In another example, the surface relief gratings include an input-coupling diffractive optical element (DOE), a redirection DOE, and an output-coupling DOE, and in which the redirection DOE and output-coupling DOE provide for exit pupil expansion of virtual images out-coupled by the waveguide combiner in two directions. In another example, the computing device is implemented in a mixed-reality head-mounted display (HMD) device in which portions of the waveguide combiner are transparent and a user of the HMD device views a real-world environment through the transparent portion and the waveguide combiner overlays virtual images over the real-world views.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for executing a simulation for light propagation in a waveguide combiner comprising a transparent waveguide and one or more optical elements that alter the light propagation, the method comprising:
modeling a geometry of the waveguide combiner as a stack of two-dimensional layers, each of the layers having zero thickness;
using a plurality of vertex points to define boundaries of the waveguide and optical elements on each of the layers of the modeled waveguide combiner geometry;
discretizing the waveguide combiner geometry into a plurality of cells by superimposing a grid on each of the respective layers of the modeled waveguide combiner geometry;
modeling light as an aggregate amount of optical power stored in a cell; and
executing the simulation by performing computations of interactions of the stored optical power in each cell with neighboring cells.

2. The method of claim 1 in which the neighboring cells share a common layer.

3. The method of claim of claim 1 in which the neighboring cells are in different layers.

4. The method of claim 3 in which light is modeled as propagating in a common direction and the waveguide combiner geometry is rotated when computing interactions among cells in different layers.

5. The method of claim 1 further including rotating the waveguide combiner geometry.

6. The method of claim 1 in which the computations are performed stepwise.

7. The method of claim 1 further including defining properties of the optical elements.

8. The method of claim 1 in which the cells are each uniformly rectangular.

9. The method of claim 1 in which the one or more optical elements include diffractive optical elements.

10. The method of claim 9 in which the properties of the diffractive optical elements include one or more of grating vector orientation, refractive index, grating depth, duty cycle, grating period, depth modulation, duty cycle modulation, slant angle modulation, or fill factor.

11. The method of claim 1 in which the one or more optical elements each have a type comprising one of surface relief grating, reflective optical element, holographic coupler, resonant waveguide gratings, metasurface couplers, or a combination of types.

12. One or more hardware-based non-transitory computer-readable memory devices storing computer-executable instructions which, upon execution by a processor in a computing device, cause the computing device to:
implement a neural network for an optical waveguide, the neural network having a shape and properties defined by a grid of cells that is superimposed over a geometry of the waveguide comprising a stack of two-dimensional layers;
discretize a k-vector space into a plurality of bins in which each k-vector bin is associated with a unique layer in the stack;
execute a simulation of light propagation in the waveguide using the neural network by which light is modeled as a series of cell interactions using intra-layer and inter-layer couplings;
perform a stepwise computation of cell state for each of the cells in the neural network; and
terminate the simulation responsive to the cells reaching a steady state.

13. The one or more hardware-based non-transitory computer-readable memory devices of claim 12 in which intra-layer couplings comprise each cell in a layer having a single input and a single output.

14. The one or more hardware-based non-transitory computer-readable memory devices of claim 12 in which the inter-layer couplings comprise a portion of light determined by rotation of k-vectors in a bin in a layer to determine overlapping cells in adjacent layers, and in which the executed instructions further cause the computing device to compute a state for overlapping cells based on a coupling strength.

15. The one or more hardware-based non-transitory computer-readable memory devices of claim 14 in which the inter-layer couplings are provided by diffractive optical elements disposed on or in the waveguide.

16. The one or more hardware-based non-transitory computer-readable memory devices of claim 12 in which weights for the neural network are based on physical characteristics and geometry of the waveguide without utilization of machine learning, and in which the weights are held constant during execution of the simulation.

17. A computing device, comprising:
a processor; and
one or more hardware-based non-transitory computer-readable memory devices storing computer-executable instructions which, upon execution by the processor cause the computing device to implement a simulation of light propagation in a waveguide combiner including a waveguide on which surface relief gratings are disposed, comprising:
creating a discretized grid-based model of the waveguide combiner by modeling the waveguide combiner as a stack of two-dimensional layers in which each layer is divided into a grid of cells using a non-continuous coordinate system;
discretizing k-vectors for the waveguide combiner into a non-continuous k-vector space in which k-vectors are divided into individual bins that are respectively mapped to each of the layers; and
executing the simulation as a stepwise series of computations to determine light energy that is exchanged among immediately neighboring cells.

18. The computing device of claim 17 in which the immediately neighboring cells comprise inter-layer cells and intra-layer cells.

19. The computing device of claim 17 in which the surface relief gratings include an input-coupling diffractive optical element (DOE), a redirection DOE, and an output-coupling DOE, and in which the redirection DOE and output-coupling DOE provide for exit pupil expansion of virtual images out-coupled by the waveguide combiner in two directions.

20. The computing device of claim 17 as implemented in a mixed-reality head-mounted display (HMD) device in which portions of the waveguide combiner are transparent and a user of the HMD device views a real-world environment through the transparent portion and the waveguide combiner overlays virtual images over the real-world views.
